(19) United States
(12) Patent Application Publication
(10) Pub. No.: US 2012/0314292 A1
(43) Pub. Date: Dec. 13, 2012

(54) OPTICAL DEVICE FORMED OF AN ARRAY OF SUB-WAVELENGTH GRATINGS

(76) Inventors: Sagi Varghese Mathai, Palo Alto, CA (US); Jingjing Li, Palo Alto, CA (US); Paul Kessler Rosenberg, Sunnyvale, CA (US)

(21) Appl. No.: 13/387,086

(22) PCT Filed: Jan. 29, 2010
(86) PCT No.: PCT/US10/22628

§ 371 Date: Jan. 25, 2012

(51) Int. Cl. G02B 27/44; G05B 19/18

(52) U.S. Cl. 359/575; 359/569; 700/97

(57) ABSTRACT

An optical device includes a substantially planar substrate and a lens array disposed on the substantially planar substrate. The lens array is formed of a plurality of distinct sub-wavelength gratings, in which the sub-wavelength gratings are selected to produce a desired phase change in beams of light that are at least one of reflected and refracted by the sub-wavelength gratings of the lens array.

### CROSS-REFERENCE TO RELATED APPLICATIONS

The present application has the same Assignee and shares some common subject matter with PCT Application No. PCT/US2009/051026, entitled “NON-PERIODIC GRATING REFLECTORS WITH FOCUSING POWER AND METHODS FOR FABRICATING THE SAME”, filed on Jul. 17, 2009, PCT Application Serial No. PCT/US2009/058006, entitled “OPTICAL DEVICES BASED ON DIFFRACTION GRATINGS”, filed on Sep. 23, 2009, and U.S. patent application Ser. No. ______ (Attorney Docket No. 200903796-1), entitled “DYNAMICALLY VARYING AN OPTICAL CHARACTERISTIC OF A LIGHT BEAM”, filed on even date herewith, the disclosures of which are hereby incorporated by reference in their entireties.

### BACKGROUND

Minimizing and/or increasing the beam width of a beam of light are important in a number of technology areas. For example, a minimized, or “spot size” of a focused beam of light is important for writing data to, or reading data from, an optical disk.

A cross-sectional view of a conventional lens device 10 is depicted in FIG. 1. As shown therein, the conventional lens device 10 includes a plurality of lens elements 12 positioned on a substrate 14. The lens elements 12 have heights 20 and widths 22 that are at least 50 microns due to the current manufacturing processes available and the refractive index of the material used to fabricate the lens elements 10.

In order to obtain a small spot size, a beam is typically passed through the lens elements 12, which have a relatively high numerical aperture (“NA”). The NA of a convex lens can be increased by increasing the diameter of the lens and shortening the focal length. However, incorporating such lenses in optical-based devices may be cost prohibitive because of the difficulty in fabricating very small lenses with large curvatures and because of the precise polishing needed to make the lenses aberration free. In addition, conventional convex and concave lenses may not be compatible with planar integrated circuits.

### BRIEF DESCRIPTION OF THE DRAWINGS

Embodiments are illustrated by way of example and not limited in the following figure(s), in which like numerals indicate like elements, in which:

FIG. 1 shows a cross-sectional view of a conventional lens device;

FIG. 2 illustrates a perspective view of an optical device having a lens array of sub-wavelength dielectric gratings, according to an embodiment of the invention;

FIG. 3 illustrates a top plan view of a sub-wavelength dielectric grating depicted in FIG. 2, according to an embodiment of the invention;

FIG. 4 shows a cross-sectional view of lines from two separate sub-patterns and the phase acquired by redirected light, according to an embodiment of the invention;

FIGS. 5A and 5B, respectively, illustrate cross-sectional views of lines in FIG. 4 revealing how the wavefront changes, according to embodiments of the invention;

FIG. 6 illustrates an isometric view of an example of a phase contour map produced by a particular arrangement of SWGs having particular grating arrangements, according to an embodiment of the invention;

FIG. 7A shows a side view of an optical device with a lens array formed of SWGs configured to focus incident light to a focal point, according to an embodiment of the invention;

FIG. 7B shows a side view of an optical device with a lens array formed of SWGs configured and operated as a diverging mirror and/or lens, according to an embodiment of the invention;

FIG. 8 shows a flow diagram of a method of fabricating an optical device having a lens array formed of a plurality of distinct SWGs, according to an embodiment of the invention; and

FIG. 9 shows a schematic representation of a computing device configured in accordance with embodiments of the present invention.

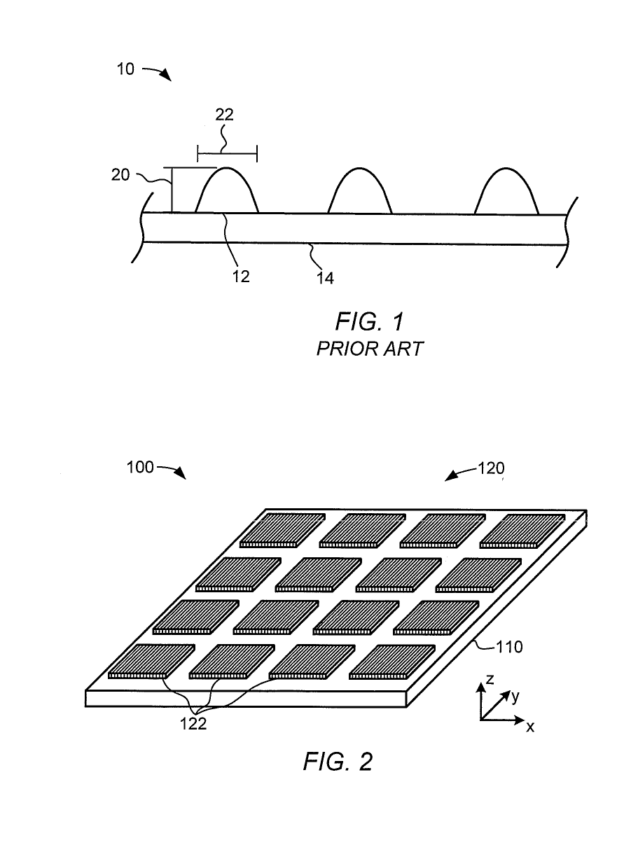

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

Disclosed herein are embodiments directed to an optical device having a substantially planar substrate and a lens array disposed on the substantially planar substrate. The lens array is formed of distinct sub-wavelength dielectric gratings (“SWGs”), in which the SWGs are selected to refract and/or reflect light. In one regard, each of the SWGs in the lens array may operate as an independent lens and/or mirror. The lens array has a thickness that is smaller than the wavelengths of colors of light, for instance, on the order of about 50-300 nanometers. In this regard, the lens array disclosed herein is significantly smaller than the lens elements employed in conventional optical devices, and thus requires substantially less material than conventional optical devices. As such, through implementation of the embodiments disclosed herein, optical devices that are significantly smaller than conventional optical devices may be fabricated for use in various applications. For instance, the optical devices disclosed herein may be employed as mirrors or other types of optical devices.

The SWGs of the lens array are composed of a relatively higher refractive index material than the material used to form the substrate on which the SWGs are disposed. As discussed herein, a refractive index of about 1.3 or greater may be considered as being a high refractive index. In addition, the SWGs generally operate to control wavefront shapes in beams of light that are redirected by the SWGs in the lens array. Generally speaking, the period and duty cycle of the lines forming the SWGs are designed for each of the SWGs in the array to control the wavefront shapes as desired. In one regard, a uniform magnitude of refraction across the optical device may be achieved, but at each SWG, the phase of refraction coefficient will be varied. In other words, if a plane wave is sent through a particular SWG, the refractive wave will have a uniform magnitude, but the phase of the wave will be varied according to the design of that particular SWG. By selectively designing and arranging the SWGs according to the wavefront shapes of the SWGs, a combined wavefront from the SWGs having desired characteristics may be produced. In one regard, the optical device of the present invention may have a substantially planar structure, but may still operate as a refractive lens similar to conventional parabolic lenses or spherical lenses.

In one example, the optical devices disclosed herein may be employed in parallel optical interconnect applications, in which, multiple lasers are arranged in a linear and periodic fashion, such as, for instance, at a 250 micron pitch. In this example, the individual SWGs of the optical devices may be constructed for placement downstream of the lasers at a similar arrangement to the lasers to individually refract and/or reflect the light beams emitted by the individual lasers. The SWGs of the optical devices may also be constructed for placement upstream of a light receptor and may also be configured to focus, collimate, or disperse light prior to receipt by the light receptor.

In another example, the SWGs may be arranged on the lens array to function as alignment marks. The SWGs of this example may be employed to align the lens array to a laser or photodetector array by a vision system. In this example, some or all of the SWGs forming the lens array may be simultaneously fabricated with SWGs configured to redirect light emitted therethrough.

In the following description, the term “light” refers to electromagnetic radiation with wavelengths in the visible and non-visible portions of the electromagnetic spectrum, including infrared and ultra-violet portions of the electromagnetic spectrum.

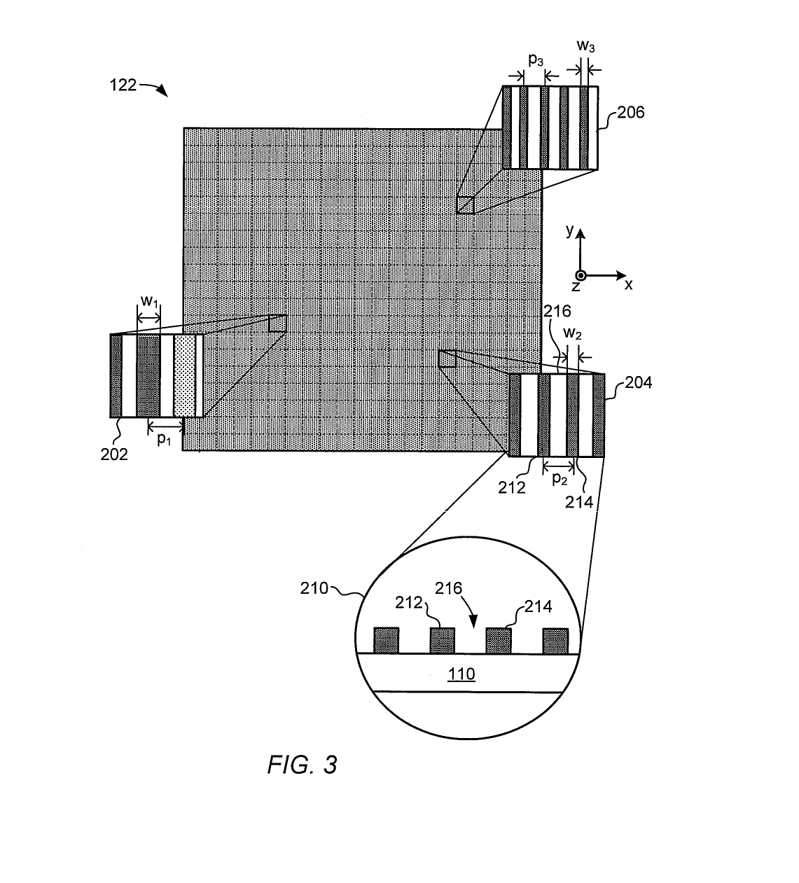

With reference first to FIG. 2, there is shown a perspective view of an optical device 100, according to an embodiment. It should be understood that the optical device 100 depicted in FIG. 2 may include additional components and that some of the components described herein may be removed and/or modified without departing from a scope of the optical device 100.

As depicted in FIG. 2, the optical device 100 includes a substrate 110 and a lens array 120 disposed on the substrate 110. The lens array 120 is composed of a plurality of distinct SWGs 122. Although the lens array 120 has been depicted as including a 4×4 array of SWGs 122, it should be understood that the lens array 120 may be a one or two-dimensional array of SWGs 122. In addition, each of the SWGs may be configured similarly to the SWGs disclosed in the copending PCT applications PCT/US2009/051026 and PCT/US2009/058006 discussed above. As discussed in those applications, each of the SWGs 122 is composed of a relatively higher refractive index material than a substrate 110 on which the SWGs 122 are disposed. For example, the SWGs 122 may be composed of silicon (“Si”) and the substrate 110 may be composed of quartz or silicon dioxide (“SiO₂”), or the SWGs 122 may be composed of gallium arsenide (“GaAs”) and the substrate 110 may be composed of aluminum gallium arsenide (“AlGaAs”) or aluminum oxide (“Al₂O₃”).

According to an embodiment, various ones of the SWGs 122 are configured to produce different wavefront shapes in a beam of light reflected and/or refracted by the SWGs 122 as compared with other ones of the SWGs 122. Thus, for instance, multiple ones of the SWGs 122 may be employed to cause light beams to become focused at a particular point, to be dispersed from a particular point, or for the light beams to be collimated. The SWGs 122 may also be configured and positioned to enable the optical device 100 to behave like a relatively complex optical device, such as, a Fresnel lens, without the relatively complex configurations required of conventional optical devices configured to perform such functions. Through selection and placement of the SWGs 122 having particular reflectance and/or refractive properties, the reflectance and/or reflective properties of the optical device 100 may substantially be controlled. Thus, according to this embodiment, the SWGs 122 may be individually configured to have desired characteristics to collectively produce desired reflective and/or refractive characteristics of the optical device 100 as a whole or to produce desired reflective and/or refractive characteristics at each of the individual SWGs 122.

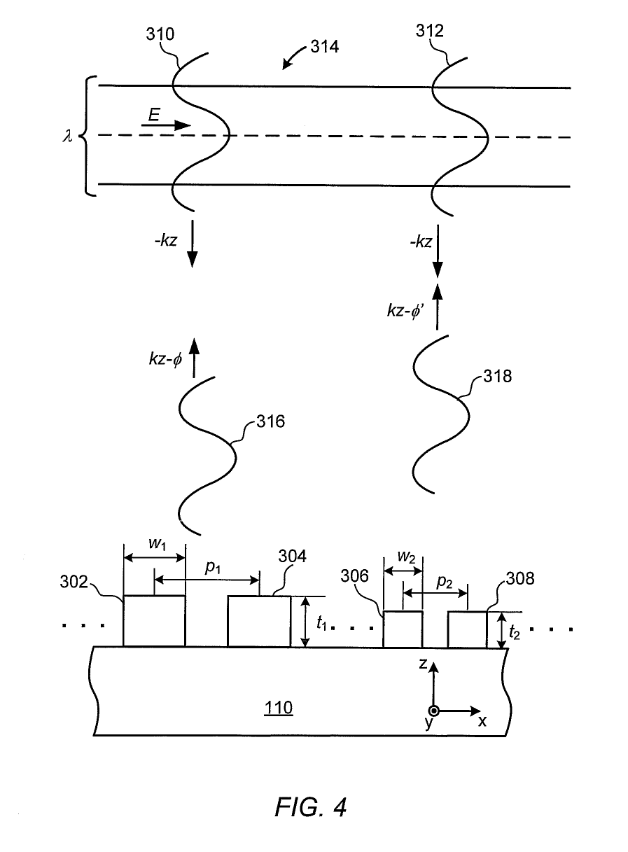

The particular reflectance and/or refractive properties of each of the SWGs 122 are determined by the grating pattern selected for the SWGs 122. An example of a grating pattern for a SWG 122 is depicted in FIG. 3, which shows a top plan view of a SWG 122 configured with a one-dimensional grating pattern. The one-dimensional grating pattern is composed of a number of one-dimensional grating sub-patterns. In the example shown in FIG. 3, three exemplary grating sub-patterns 202-206 have been enlarged. Each grating sub-pattern comprises a number of regularly spaced wire-like portions of the SWG 122 material called “lines” disposed on the surface of the substrate 110. The lines extend in the y-direction and are periodically spaced in the x-direction. Also shown in FIG. 3 is an enlarged end-on view 210 of the grating sub-pattern 204. The shaded rectangles 212 and 214 represent lines composed of a relatively higher index material than the substrate 110 and are separated by a groove 216 extending in the z-direction and exposing the surface of the substrate 110. Each of the sub-patterns in the SWG 122 is characterized by any particular periodic spacing of lines and by the line width in the x-direction. For example, the sub-pattern 202 includes lines of width w₁ separated by a period p₁, the sub-pattern 204 comprises lines with width w₂ separated by a period p₂, and the sub-pattern 206 comprises lines with width w₃ separated by a period p₃.

The grating sub-patterns 204-206 form sub-wavelength gratings configured to reflect incident light polarized in one direction, for instance, the x direction, provided that the periods p₁, p₂, and p₃ are smaller than the wavelength of the incident light. For example, the lines widths may range from approximately 10 nm to approximately 300 nm and the periods may range from approximately 20 nm to approximately 1 μm depending on the wavelength of the incident light. The light reflected from a region acquires a phase φ determined by the line thickness t, and the duty cycle η determined by:

$$η = \frac{w}{p}$$

where w is the line width and the p is the period of the lines associated with the region.

The SWG 122 may be configured to reflect and/or refract the x-polarized component or the y-polarized component of the incident light by adjusting the period, line width and line thickness of the lines. For example, a particular period, line width and line thickness may be suitable for reflecting the x-polarized component but not for reflecting the y-polarized component; and a different period, line width and line thickness may be suitable for reflecting the y-polarized component but not for reflecting the x-polarized component.

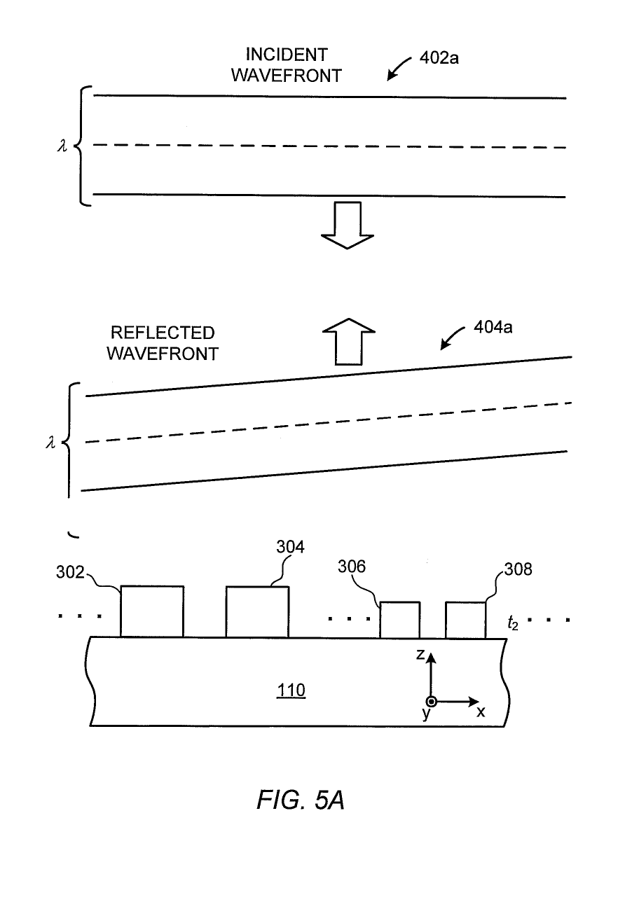

Each of the grating sub-patterns 202-206 also reflects and/or refracts incident light polarized in one direction, for instance, the x-direction, differently due to the different duty cycles and periods associated with each of the sub-patterns. With reference now to FIG. 4, there is shown a cross-sectional view of lines from two separate sub-patterns and the phase acquired by reflected and/or refracted light, according to an embodiment. For example, lines 302 and 304 are lines in a first sub-pattern and lines 306 and 308 are lines in a second sub-pattern located elsewhere on the substrate 110. The thickness t₁ of the lines 302 and 304 is greater than the thickness t₂ of the lines 306 and 308, and the duty cycle η₁ associated with the lines 302 and 304 is also greater than the duty cycle η₂ associated with the lines 306 and 308. Light polarized in the x-direction and incident on the lines 302-308 becomes trapped by the lines 302 and 304 for a relatively longer period of time then the portion of the incident light trapped by the lines 306 and 308. As a result, the portion of light reflected from and/or refracted by the lines 302 and 304 acquires a larger phase shift then the portion of the light reflected from the lines 306 and 308. As shown in FIG. 4, the incident waves 310 and 312 strike the lines 302-308 with approximately the same phase, but the wave 316 reflected from and/or refracted from the lines 302 and 304 acquires a relatively larger phase shift φ than the phase φ′(φ>φ′) acquired by the wave 318 reflected from and/or refracted by the lines 306 and 308.

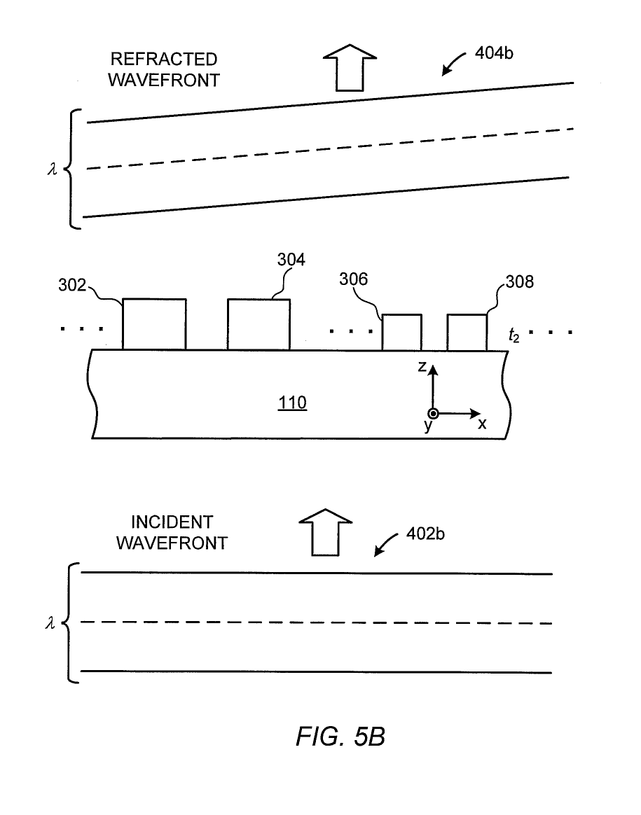

Turning now to FIGS. 5A and 5B, there are shown respective cross-sectional views of the lines 302-308 revealing how the wavefront changes in accordance with embodiments of the present invention. As shown in FIG. 5A, incident light with a substantially uniform wavefront 402a strikes through the lines 302-308 and the substrate 110 producing reflected light with a curved reflected wavefront 404a. The curved reflected wavefront 404a results from portions of the incident light 402a interacting with the lines 302 and 304 with a relatively larger duty cycle η₁ and thickness t₁ than portions of the same incident wavefront 402a interacting with the lines 306 and 308 with a relatively smaller duty cycle η₂ and thickness t₂. The shape of the reflected wavefront 404a is consistent with the larger phase acquired by light striking the lines 302 and 304 relative to the smaller phase acquired by light striking the lines 306 and 308.

As shown in FIG. 5B, incident light with a substantially uniform wavefront 402b passes through the lines 302-308 and the substrate 110 producing refracted light with a curved refracted wavefront 404b. The curved refracted wavefront 404b results from portions of the incident light 402b interacting with the lines 302 and 304 with a relatively larger duty cycle η₁ and thickness t₁ than portions of the same incident wavefront 402b interacting with the lines 306 and 308 with a relatively smaller duty cycle η₂ and thickness t₂. The shape of the refracted wavefront 404b is consistent with the larger phase acquired by light passing through the lines 302 and 304 relative to the smaller phase acquired by light passing through the lines 306 and 308.

The SWGs 122 are configured to apply a particular phase change to reflected/refracted light while maintaining a very high reflectivity/refractivity. In particular, a SWG 122 configured with a one-dimensional grating pattern may apply a phase change to reflected/refracted light polarized perpendicular to the lines, as described above. An example of a phase change contour map produced by a particular grating pattern on a SWG is depicted in the copending PCT Application No. PCT/US2009/051026.

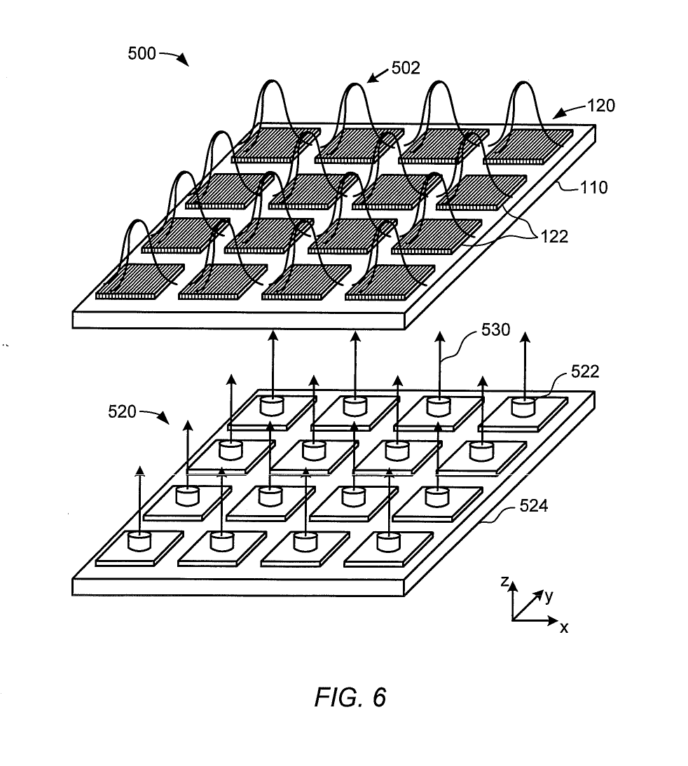

According to an embodiment, the SWGs 122 are configured and positioned on the substrate 110 to produce a desired phase change in a beam of light reflected from and/or refracted by the sub-wavelength gratings of the lens array 120. An example of phase contour maps 502 produced by the SWGs 122 in the lens array 120 is depicted in FIG. 6. FIG. 6, more particularly, depicts an isometric view 500 of the example of the phase contour maps 502 produced by the SWGs 122 having particular grating arrangements, in accordance with an embodiment of the invention.

Also shown in FIG. 6 is a light source 520 formed of an array of laser sources 522 arranged on a substrate 524, according to an example. As shown therein, light beams (represented by the arrows) 530 are directed toward each of the SWGs 122. In addition, each of the SWGs 122 generally operates to reflect and/or refract the light beams 530 as indicated by each of the contour maps 502. By way of particular example, the SWGs 122 may have identical contour maps such that each SWG 122 is configured to collimate the light beams 530 received from the array of light sources 522.

Each of the contour maps 502 represents the magnitude of the phase change acquired by light reflected from and/or refracted by the SWGs 122. In the example shown in FIG. 6, the SWGs 122 produce tilted Gaussian-shaped phase contour maps 502 with the largest magnitude in the phase acquired by the light reflected from and/or reflected by the SWGs 122 located near the centers of each of the SWGs 122. In addition, the magnitude of the phase acquired by the reflected light is also depicted as decreasing away from the center of the optical device 100.

The phase change in turn shapes the wavefront of light reflected from and/or refracted by each SWG 122 in the lens array 120. For example, as described above with reference to FIG. 6, lines having a relatively larger duty cycle produce a larger phase shift in reflected light than lines having a relatively smaller duty cycle. As a result, a first portion of a wavefront reflected from and/or refracted by the SWGs 122 formed of lines having a first duty cycle lags behind a second portion of the same wavefront reflected from and/or refracted by a second portion of the same SWG 122 formed of lines having a second relatively smaller duty cycle. Embodiments of the present invention include patterning each of the SWGs 122 to control the phase change resulting from each of the SWGs 122 and positioning the SWGs 122 to enable the lens array 120 to be operated as an optical device with particular optical properties, such as a focusing mirror or a diverging mirror.

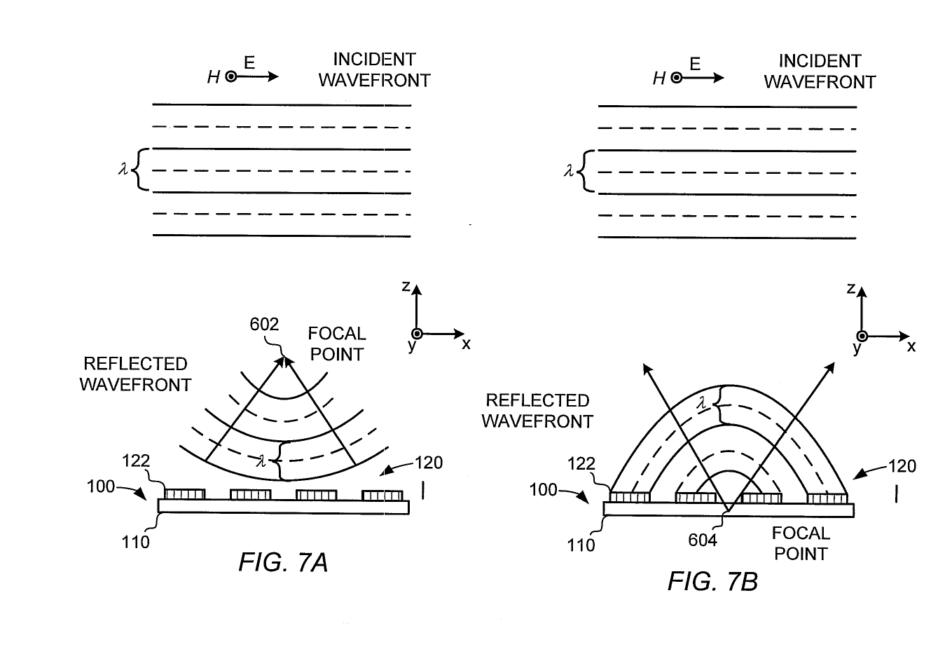

FIG. 7A shows a side view of an optical device 100 with a lens array 120 formed of SWGs 122 configured to focus incident light to a focal point 602 in accordance with embodiments of the present invention. In the example of FIG. 7A, the SWGs 122 are configured with a grating pattern and are arranged in the lens array 120 so that incident light polarized in the x-direction is reflected and/or refracted with a wavefront corresponding to focusing the light at the focal point 602. On the other hand, FIG. 7B shows a side view of an optical device 100 with a lens array 120 formed of SWGs 122 configured and operated as a diverging mirror or lens in accordance with embodiments of the present invention. In the example of FIG. 7B, the SWGs 122 are configured with a grating pattern and are arranged in the lens array 120 so that incident light polarized in the x-direction is reflected and/or refracted with a wavefront corresponding to light emanating from a focal point 604.

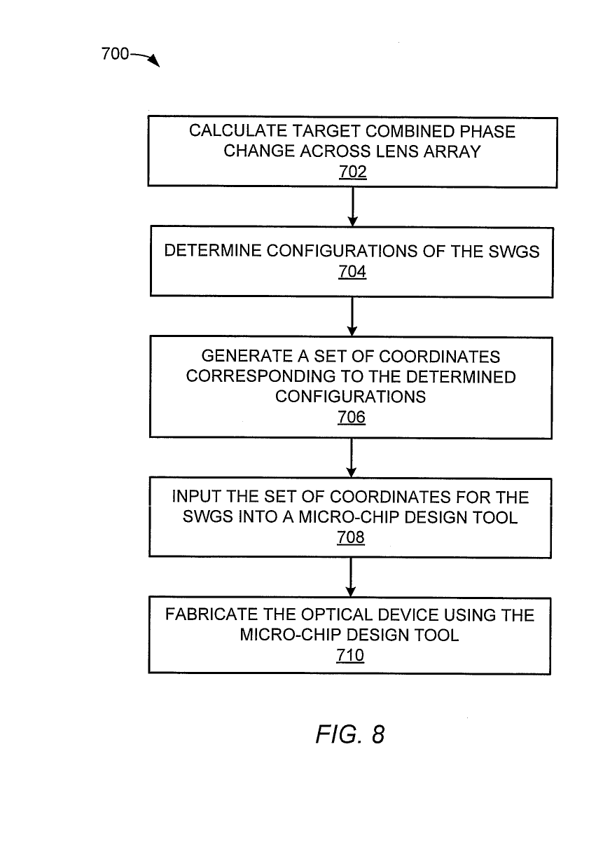

Turning now to FIG. 8, there is shown a flow diagram of a method 700 of fabricating an optical device 100 having a lens array formed of a plurality of distinct SWGs 122, according to an embodiment. It should be understood that the method 700 of fabricating the optical device 100 depicted in FIG. 2 may include additional steps and that some of the steps described herein may be removed and/or modified without departing from a scope of the method 700 of fabricating the optical device 100.

At step 702, a target phase change across the lens array 120 is calculated by a computing device. The target phase change corresponds to a desired wavefront shape in beams of light redirected by the SWGs 122 of the lens array 122. Accordingly, the target phase change may be calculated based upon an intended implementation of the lens array 120. Thus, for instance, if the intended implementation of the lens array 120 is to cause light beams to converge to a focal point as depicted, for instance, in FIG. 7A, the computing device may calculate the phase change required of the individual SWGs 122 to cause the light beams that are at least one reflected and refracted by the SWGs 122 to converge to the focal point.

According to an example, the computing device implements a rigorous wave analysis to calculate the target phase change across the lens array 120 at step 702. In addition, the computing device may determine a target phase change across each of the SWGs 122 that results in the target combined phase change across the lens array 120. Examples of various manners in which the computing device may determine the target phase changes across each of the SWGs 122 are described in the copending PCT Application No. PCT/US2009/051026.

At step 704, the computing device determines configurations of the SWGs 122 in the lens array 120 corresponding to the calculated target phase change. More particularly, for instance, the computing device may determine line widths, line period spacing, and line thicknesses corresponding to the target phase change determined for each of the SWGs 122 based upon the locations of the SWGs 122 in the lens array 120. According to a particular example, the computing device may implement a finite element analysis operation to determine the configurations of each of the SWGs 122. Examples of various manners in which the computing device may determine the configurations of each of the SWGs 122 are described in the copending PCT Application No. PCT/US2009/051026.

At step 706, the computing device generates a set of coordinates corresponding to the determined configurations of the SWGs 122. The set of coordinates may be generated to define the placements and configurations of each of the lines forming each of the SWGs 122 on the substrate 110.

At step 708, the set of coordinates for the SWGs 122 is inputted into a micro-chip design tool. In addition, at step 710, the optical device having the determined lens array 120 configuration is fabricated using the micro-chip design tool. According to an example, the micro-chip design tool is configured to pattern the lines of the SWGs 122 directly on a first layer of material placed on surface of the substrate 110. According to another example, the micro-chip design tool is configured to define a grating pattern of the lines in an imprint mold, which may be used to imprint the lines into a first layer positioned on the surface of the substrate 110. In this example, the imprint mold may be implemented to stamp the pattern of the lines into the first layer. Although particular examples of manners in which the lens array 120 may be fabricated have been described, it should be understood that any reasonably suitable fabrication technique may be employed. Examples of other suitable manners include imprint lithography, optical lithography, roll-to-roll imprinting, chemical vapor deposition, sputtering, etching, etc.

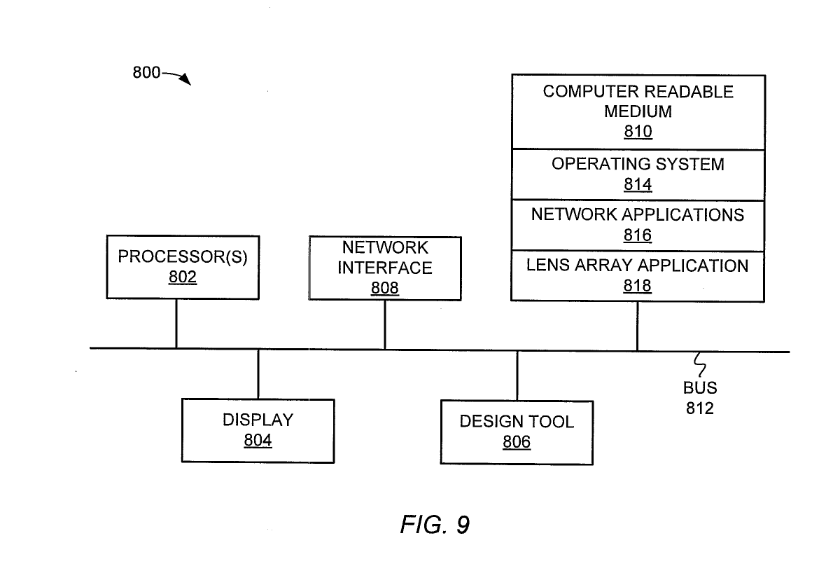

The methods employed to generate the SWG 122 grating pattern data of the lens array 120 with reference to FIG. 8 may thus be implemented by the computing device, which may be a desktop computer, laptop, server, etc. Turning now to FIG. 9, there is shown a schematic representation of a computing device 800 configured in accordance with embodiments of the present invention. The device 800 includes one or more processors 802, such as a central processing unit; one or more display devices 804, such as a monitor; a design tool interface 806; one or more network interfaces 808, such as a Local Area Network LAN, a wireless 802.11x LAN, a 3G mobile WAN or a WiMax WAN; and one or more computer-readable mediums 810. Each of these components is operatively coupled to one or more buses 812. For example, the bus 812 may be an EISA, a PCI, a USB, a FireWire, a NuBus, or a PDS.

The computer readable medium 810 may be any suitable medium that participates in providing instructions to the processor 802 for execution. For example, the computer readable medium 810 can be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 810 can also store other software applications, including word processors, browsers, email, Instant Messaging, media players, and telephony software.

The computer-readable medium 810 may also store an operating system 814, such as Mac OS, MS Windows, Unix, or Linux; network applications 816; and a grating application 818. The operating system 814 may be multi-user, multiprocessing, multitasking, multithreading, real-time and the like. The operating system 814 may also perform basic tasks such as recognizing input from input devices, such as a keyboard or a keypad; sending output to the display 804 and the design tool 806; keeping track of files and directories on medium 810; controlling peripheral devices, such as disk drives, printers, image capture device; and managing traffic on the one or more buses 812. The network applications 816 includes various components for establishing and maintaining network connections, such as software for implementing communication protocols including TCP/IP, HTTP, Ethernet, USB, and FireWire.

The lens array application 818 provides various software components for generating grating pattern data, as described above. In certain embodiments, some or all of the processes performed by the application 818 may be integrated into the operating system 814. In certain embodiments, the processes can be at least partially implemented in digital electronic circuitry, or in computer hardware, firmware, software, or in any combination thereof.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

1. An optical device formed of an array of sub-wavelength gratings, said optical device comprising:
a substantially planar substrate; and
a lens array disposed on the substantially planar substrate, said lens array being formed of a plurality of distinct sub-wavelength gratings, wherein the sub-wavelength gratings are selected to produce a desired phase change in beams of light that are at least one of reflected and refracted by the sub-wavelength gratings of the lens array.

2. The optical device according to claim 1, wherein a particular sub-wavelength grating is configured to produce a different desired wavefront shape in the beam of light than another particular sub-wavelength grating.

3. The optical device according to claim 1, wherein each of the sub-wavelength gratings has a planar geometry and is configured with lines, the lines widths, line thicknesses and line period spacings being selected to control phase changes in different portions of the beam of light that is at least one of reflected from and refracted by the sub-wavelength grating such that the phase changes collectively produce a desired wavefront shape in the beam of light that is at least one of reflected from and refracted by the sub-wavelength grating.

4. The optical device according to claim 3, wherein the sub-wavelength gratings are composed of a material having a relatively higher refractive index than the refractive index of the substrate.

5. The optical device according to claim 1, wherein the lens array comprises a one-dimensional lens array.

6. The optical device according to claim 1, wherein the lens array comprises a two-dimensional lens array.

7. The optical device according to claim 1, wherein the desired wavefront shape in a beam of light comprises a wavefront shape similar to a wavefront shape generated by a Fresnel lens.

8. The optical device according to claim 1, wherein the sub-wavelength gratings have a thickness between about 50-300 nanometers.

9. The optical device according to claim 1, wherein the sub-wavelength gratings are arranged in the lens array to function as vision-based alignment marks.

10. A method for fabricating an optical device having a lens array formed of a plurality of distinct sub-wavelength gratings, the method comprising:
calculating, using a computing device, a target phase change across the lens array, the target phase change corresponding to a desired wavefront shape in beams of light that are at least one of reflected and refracted by the sub-wavelength gratings of the lens array;
determining, using the computing device, configurations of the sub-wavelength gratings in the lens array corresponding to the calculated target phase change; and
generating, using the computing device, a set of coordinates corresponding to the determined configurations of the sub-wavelength gratings in the lens array.

11. The method according to claim 10, wherein determining configurations of the sub-wavelength gratings further comprises determining line widths, line period spacing, and line thickness corresponding to a target phase change for each of the sub-wavelength gratings, and wherein generating the set of coordinates further comprises generating the set of coordinates for the lines in each of the sub-wavelength gratings.

12. The method according to claim 11, further comprising:
inputting the set of coordinates for the sub-wavelength gratings into a micro-chip processing tool; and
implementing the micro-chip processing tool to fabricate the optical device.

13. The method according to claim 12, further comprising:
fabricating the optical device by depositing a first layer of material on a surface of a substrate, the first layer of material having a relatively higher refractive index than the substrate; and
defining a grating pattern of lines in the first layer of material using the micro-chip processing tool based upon the inputted set of coordinates.

14. The method according to claim 12, further comprising:
fabricating through implementation of a lithography operation to create the lines of the sub-wavelength gratings.

15. The method according to claim 10, wherein generating the set of coordinates corresponding to the determined configurations of the sub-wavelength gratings in the lens array using the computing device further comprises generating the set of coordinates to cause lines forming the sub-wavelength gratings to have non-periodic spacings with respect to each other.
